(19) United States
(12) Patent Application Publication
(10) Pub. No.: US 2005/0194423 A1
(43) Pub. Date: Sep. 8, 2005

(54) Ultrasonic bonding apparatus and method

(75) Inventor: Takanori Okita, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Renesas Technology Corp., Tokyo (JP)

(21) Appl. No.: 10/658,557

(22) Filed: Sep. 10, 2003

(30) Foreign Application Priority Data
Mar. 12, 2003 (JP) 2003-066256

(51) Int. Cl. B23K 1/06

(52) U.S. Cl. 228/110.1; 228/1.1

(57) ABSTRACT

An ultrasonic bonding device includes a heater plate on which a lead frame having leads is positioned. A semiconductor chip is mounted on the lead frame. A holding member presses the leads of the lead frame against the heater plate. A bonding tool applies ultrasonic energy to a position where a wire is in contact with an electrode of the semiconductor chip so that the wire is bonded to the electrode. The bonding tool also applies ultrasonic energy to a position where the wire is in contact with one of the leads so that the wire is bonded to the lead. A holding surface of the holding member for contact with the leads has a surface roughness higher than that of a supporting surface zone of the heater plate for contact with the leads.

### RELATED APPLICATION

This application is based on Japanese Patent Application No. 2003-66256, the content of which being incorporated herein by reference.

### BACKGROUND OF THE INVENTION

1. Field of the Invention

The present invention generally relates to a bonding of two elements by application of ultrasonic energy to the interface therebetween, and more particularly to a wire bonding apparatus and method used in the manufacturing process of a semiconductor device.

2. Description of the Related Art

Conventionally, a semiconductor device has been known in which a semiconductor chip is mounted on a lead frame having a plurality of leads which are connected with a plurality of electrodes of the semiconductor chip via wires. Typically, the wire is bonded to an object to be bonded, i.e., the lead or the electrode using an ultrasonic wire bonding process, as disclosed in JP 3-116963 (A), for example. In this process, a bonding wire is brought into contact with the object to be bonded. Then, ultrasonic energy is applied to the wire to form a bond between the wire and the object. One conventional wire bonding device includes a capillary having a lumen therein adapted to receive a bonding wire. One end of the capillary is moved to a bonding point where a portion of the wire that is extended from the capillary is brought into contact and pressed against the object to be bonded. The capillary is then actuated to vibrate by a generator connected therewith for generating an ultrasonic vibration, thereby allowing the wire to be bonded to the object. To efficiently transmit ultrasonic energy to the bonding point, at least a region of the lead adjacent to the bonding point is clamped by a pair of support members in opposed relationship with each other as ultrasonic vibration is applied to the bonding point. The one end of the capillary is vibrated along the surface direction of the lead. To prevent a slip between the lead and the lead support member(s), non-skid surface treatment or rough surface treatment is applied to the lead support member(s).

### SUMMARY OF THE INVENTION

The object of the present invention is to provide an improved ultrasonic bonding (wire bonding) apparatus and method as compared to these conventional constructions.

To achieve the above object, an ultrasonic bonding apparatus of the present invention includes a heater plate on which a lead frame having a plurality of leads is positioned in place. A semiconductor chip with a plurality of electrodes is mounted on the lead frame. The leads of the lead frame are supported on a supporting surface zone of the heater plate. A holding member presses at least one of the leads of the lead frame against the supporting surface zone of the heater plate. A bonding tool applies ultrasonic energy to a position where a wire is in contact with an electrode of the semiconductor chip so that the wire is bonded to the electrode. The bonding tool also applies ultrasonic energy to a position where said wire is in contact with one of the leads so that the wire is bonded to the lead. A holding surface of the holding member for contact with the at least one of the leads of the lead frame has a surface roughness higher than that of the supporting surface zone of the heater plate.

An ultrasonic bonding method of the present invention includes the step of positioning a lead frame having a plurality of leads in place on a heater plate. A semiconductor chip with a plurality of electrodes is mounted on the lead frame. The leads of the lead frame are supported on a supporting surface zone of the heater plate. At least one of the leads of the lead frame are pressed against the supporting surface zone of the heater plate by a holding member. Ultrasonic energy is applied to a position where a wire is in contact with an electrode of the semiconductor chip so that the wire is bonded to the electrode. Ultrasonic energy is also applied to a position where said wire is in contact with one of the leads so that the wire is bonded to the lead. A holding surface of the holding member for contact with the at least one of the leads has a surface roughness higher than that of the supporting surface zone of the heater plate.

### BRIEF DESCRIPTION OF THE DRAWINGS

These and other objects, advantages and features of the invention will become apparent from the following description thereof taken in conjunction with the accompanying drawings in which:

FIG. 1 is a perspective view of a first embodiment of the ultrasonic bonding device according to the present invention;

FIG. 2 is a cross-sectional view of the device, taken along the line II-II of FIG. 1;

FIG. 3A is a cross-sectional view showing a contact region between the lead holding member and the lead in FIG. 2;

FIG. 3B is an enlarged cross-sectional view illustrating a holding surface of the lead holding member in FIG. 3A;

FIG. 3C is an enlarged cross-sectional view illustrating another embodiment of the holding surface of the lead holding member;

FIGS. 4A-4C are schematic diagrams showing steps of the wire bonding operation performed by the ultrasonic bonding device of FIG. 1.

FIG. 5 is a partial enlarged perspective view of a second embodiment of the ultrasonic bonding device according to the present invention;

FIG. 6A is a schematic view showing a surface to be treated of, for example, the lead holding member of a third embodiment of the ultrasonic device according to the present invention, the surface to be treated having a surface roughness within a predetermined range; and

FIG. 6B is a schematic view showing the surface in FIG. 6B, wherein its surface roughness has reached a value which falls out of the predetermined range due to an abrasion.

Corresponding reference numbers indicate corresponding parts throughout the several views of the drawings.

### DETAILED DESCRIPTION OF THE PREFERRED EMBODIMENTS

With reference to the drawings, preferred embodiments of the present invention will be described hereinafter.

### First Embodiment

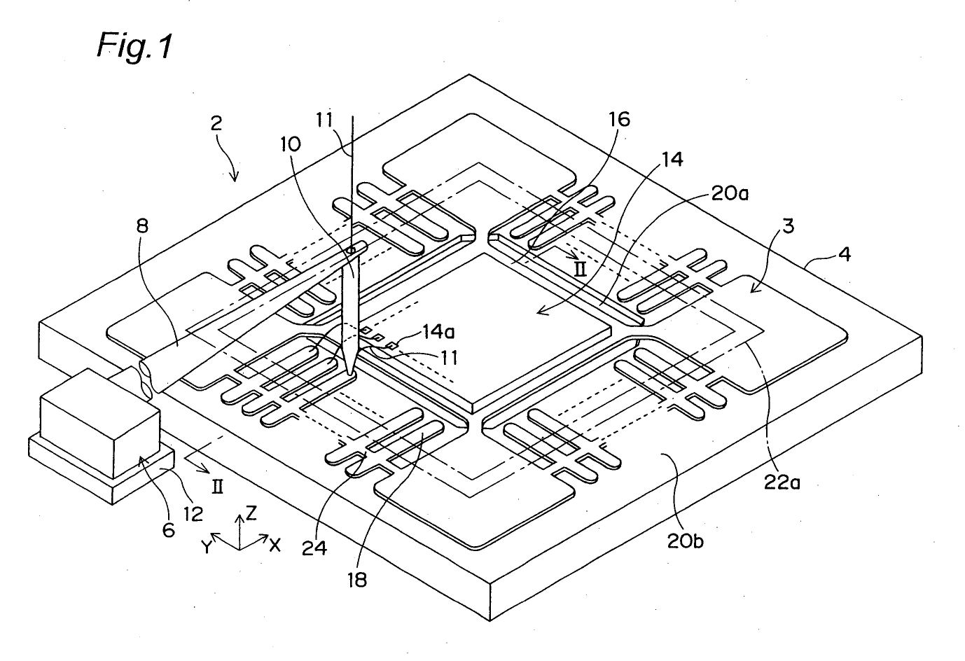

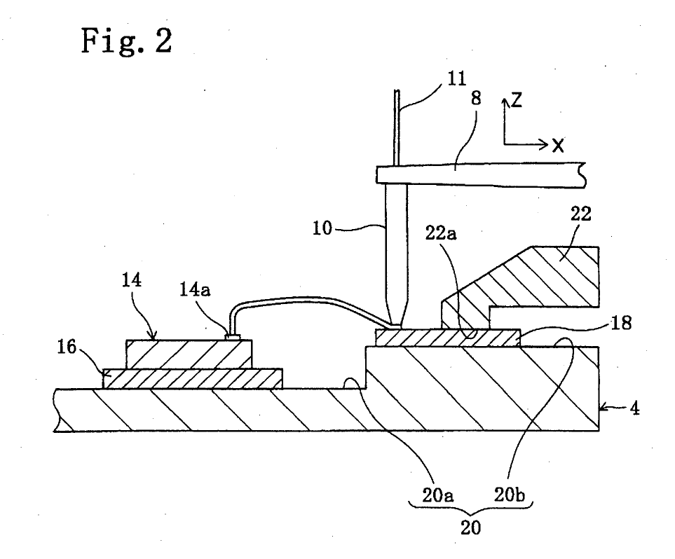

Referring to FIGS. 1 and 2, there is shown a first embodiment of the ultrasonic bonding device or wire bonding device of the present invention for connecting between a plurality of electrodes of a semiconductor chip mounted on a lead frame and a plurality of leads in the lead frame, using a thermosonic wire bonding. The device, generally indicated at 2, includes a heater plate 4 on which a lead frame 3 is positioned in place. The wire bonding device 2 also includes a bonding head 6 incorporating an ultrasonic generator (not shown) for generating an ultrasonic vibration, a horn 8 extending from the head 6 in a direction (which is referred to as X direction hereinafter), and a capillary 10 which is supported at a distal end of the horn 8 and extends in a direction (which is referred to as Z direction hereinafter) perpendicular to the X direction. The lead frame 3 extends generally in the X direction and a Y direction normal to the X and Z directions. The heater plate 4 is constructed of a metal such as stainless steel. A proximal end of the horn 8 is connected with a piezoelectric transducer (not shown), so that the activation of the ultrasonic generator allows an alternating voltage to be applied to the transducer to stimulate vibration, so that the horn 8 and consequently the distal end of the capillary 10 vibrate along the X direction. The capillary 10 includes a lumen (not shown) through which a wire 11 (e.g., gold wire) is passed.

The bonding head 6 is mounted on an XY table 12, so that the actuation of the XY table 12 enables the capillary 10 which is connected with the distal end of the horn 8 to be moved relative to the lead frame 3 in the X and Y directions. A drive mechanism (not shown) is provided for moving the horn 8 relative to the bonding head 6 in the Z direction.

The wire bonding device 2 includes an electronic flame off (not shown) which may be moved by a drive mechanism (not shown) to a position beneath the capillary 10. As described below, in a first bonding process (i.e., the wire 11 is bonded to a corresponding electrode of a semiconductor chip.), a high voltage is applied between the tip of the wire 11 extended from the capillary 10 and the electronic flame off so that an electrical discharge is produced to melt the tip of the wire 11 to provide a ball (not shown) thereon.

In the embodiment shown, the lead frame 3 has a die pad 16 on which a semiconductor chip 14 is mounted and which is depressed below a level of a plurality of leads 18 located at its periphery. It is understood that more than one semiconductor chips may be mounted on the lead frame 3. A surface 20 of the heater plate 4 for supporting the lead frame 3 has a configuration corresponding to that of the lead frame 3, i.e., it includes a first supporting surface zone 20a for supporting the die pad 16 and a second supporting surface zone 20b surrounding the first supporting surface zone 20a for supporting the leads 18. The first and second supporting surface zones 20a and 20b extend generally in the X and Y directions, respectively. In the embodiment, a surface treatment is applied to the second supporting surface zone 20b so that a roughness thereof falls within a given range, which will be described below.

As shown in FIG. 1, the plurality of leads 18 is designed to surround the die pad 16 on all sides. In a wire bonding process, on the upper surface of each of the leads 18 is provided. a member 22 which has a surface 22a opposed to the leads 18 in the form of a rectangular frame that surrounds the die pad 16 and, in combination with the heater plate 4, serves to engage the leads 18 therebetween. As for the lead holding member 22, for clarity in illustration, only the holding surface 22a is shown in FIG. 1. A pressure is applied to the lead holding member 22 so that it is biased toward the heater plate 4. In the embodiment, a surface treatment is applied to the lead holding surface 22a so that it has a surface roughness higher than that of the second supporting surface zone 20b. At least the lead holding surface 22a and its vicinity of the lead holding member 22 is constructed of a metal such as stainless steel.

It is noted that, after the wire bonding process, elements such as the semiconductor chip 14 and the wires 11 will be encapsulated in a resin to form a package body attached to the lead frame 3. In the encapsulation process, tiebars 24 that connect the neighboring leads 18 function as a barrier to minimize resin leaking from a small opening defined between upper and lower mold halves.

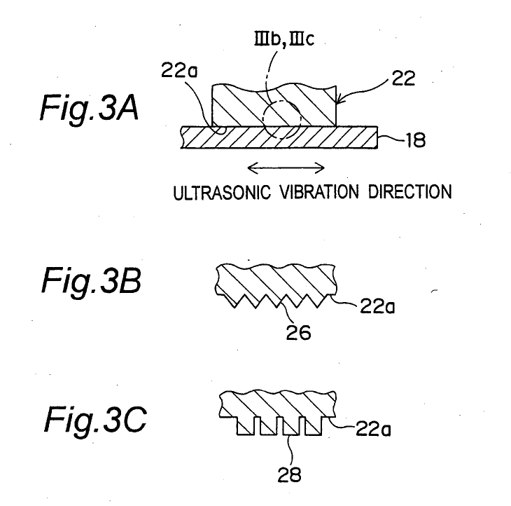

It is to be understood that the present invention is not limited to the surface treatment method of the lead holding surface 22a and second supporting surface zone 20b, which may be a shot blast, sand blast or air blast, for example. Alternatively, the lead holding surface 22a and/or the second supporting surface zone 20b may be designed to have a plurality of slots which run along a direction which is generally perpendicular to a direction of ultrasonic vibration (i.e., vibration direction of the capillary 10) indicated by an arrow in FIG. 3A. FIGS. 3B and 3C each shows an example of the holding surface zone 22b to which the surface treatment described above has been applied. In FIG. 3B, the holding surface zone 22b has a plurality of microstructures 26 each having a triangular cross-section and extending in a direction (extending across the front and rear surfaces of the drawing of FIG. 3B) which is perpendicular to the vibration direction. In FIG. 3C, the holding surface zone 22a has a plurality of microstructures 28 each having a rectangular cross-section and extending in the direction perpendicular to the vibration direction. A nitriding treatment may be applied to a surface to be treated (i.e., lead holding surface 22a and/or second supporting surface zone 20b) to which the surface treatment set forth above has been applied, in order to increase the hardness of the surface to be treated. This inhibits an abrasion of the surface to be treated, resulting in a longer operating life for the lead holding member 22 and/or heater plate 4.

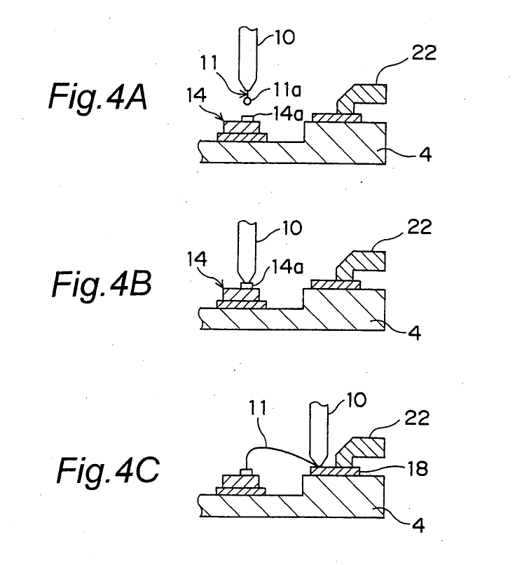

Referring now to FIGS. 1, 2 and 4A-4C, in a wire bonding operation of the wire bonding device 2 so constructed, the lead frame 3 is initially positioned in place on the heater plate 4. Next, the lead holding member 22 is located on the lead frame 3 so that the holding surface 22a is positioned on a desired region of each of the leads 18. A force is then applied to the lead holding member 22 to bias it toward the heater plate 4 so that the leads 18 are clamped by the lead holding member 22 and [symbol] 4 Thereafter, the heater plate 4 is heated [symbol] temperature of its surface 20 has reached a

[symbol]

[symbol] the other hand, with the electric flame off [symbol] ocated beneath the capillary 10, an electrical [symbol] generated between the electric flame off and [symbol] d of the wire 11 extended from the bottom end [symbol] ary 10, so that the ball 11a is formed on the [symbol] the wire (see FIG. 4A). Then, the XY table [symbol] ed so that the capillary 10 supported by the [symbol] f the horn 8 is moved to a position above the [symbol] a of the semiconductor chip 14 (i.e., first [symbol] ), as shown in FIG. 4A. The capillary 10 is [symbol] by the drive mechanism (not shown) so that the [symbol] brought into contact with and is pressed [symbol] electrode 14a, as shown in FIG. 4B. At the [symbol] the ultrasonic generator is activated to [symbol] trasonic vibration of the distal end of the [symbol] With the aid of the heating from the heater [symbol] the load from the capillary 10 (i.e., using a [symbol] sion bonding technique), the ball 11a of the [symbol] olten and bonded to the electrode 14a of the [symbol] ultrasonic energy facilitates the melting and [symbol] s such, the wire 11 is connected with the [symbol] of the semiconductor chip 14.

Thereafter, as the wire 11 is fed from the distal end of the capillary 10, it is raised to a height position. Next, the capillary 10 is moved and lowered toward the lead 18 or second bonding point, forming a loop as shown in FIG. 4C. The wire 11 is then brought into contact with and is pressed against the lead 18, as shown in FIG. 4C. At the same time, the ultrasonic generator is activated to stimulate ultrasonic vibration of the distal end of the capillary 10. Using the thermosonic bonding, the wire 11 is molten and bonded to the lead 18.

In the embodiment, since the holding surface 22a of the lead holding member 22 and the second supporting surface zone 20b of the heater plate 4 are designed to be rough, the maximum static frictional force between the lead holding member 22 and/or heater plate 4 and the leads 18 may increase. This prevents or inhibits a slip between the lead holding member 22 and/or heater plate 4 and the leads 18 in the second bonding process (i.e., the wire 11 is bonded to the corresponding lead 18). This prevents the ultrasonic energy for bonding the wire 11 to one of the leads 18 from being transmitted via, for example, the tiebar(s) 24 from the one lead 18 to its adjacent lead to which the wire has been already bonded, so that the adjacent lead may resonate until it may break. Also, the second supporting surface zone 20b of the heater plate 4 has a surface roughness lower than that of the lead holding surface 22a of the lead holding member 22. Accordingly, a sufficient amount of heat for the thermosonic bonding can be transferred from the heater plate 4 to the lead frame 3. As such, the arrangement of the present embodiment can ensure a thermal conduction from the heater plate 4 to the lead frame 3 and allow the lead holding member 22 to more effectively press the leads 18 against the heater plate 4.

### Test

A second bonding with regard to the leads was performed by the use of the wire bonding device 2 according to the embodiment under the condition described below.

### Example 1

The lead holding surface 22a had a ten-point mean roughness Rz of 1.5 μm. The second supporting surface zone 20b had a ten-point mean roughness Rz of 1.5 μm. Rz is defined at the paragraph 5.1 of “Definition and Designation of Surface Roughness” according to JIS (Japanese Industrial Standard) B 0601-1994. The lead holding member 22 had a width of 1.0 mm in contact with each lead 18. The pressing force of the lead holding member 22 against the heater plate 4 (per semiconductor chip 14) was about 20 N. The lead frame 3 having fifty leads 18 (per semiconductor chip 14) was prepared, each lead having a width of 0.1-0.2 mm. The heater plate 4 had a surface temperature of 100-300° C. The ultrasonic generator had a vibration frequency of about 60 kHz. The pressing force of the capillary 10 against the lead 18 was 100-2000 mN. The distal end of the capillary 10 had a vibration amplitude of 0.1-2 μm.

### Example 2

The condition was identical to that of example 1 except that the lead holding surface 22a had a ten-point mean roughness Rz of 10 μm.

### Example 3

The condition-was identical to that of example 1 except that the lead holding surface 22a had a ten-point mean roughness Rz of 30 μm.

### Test Results

Where both the lead holding surface 22a and second supporting surface zone 20b had a Rz of 1.5 μm, there was a case where in the second bonding process the lead to which the wire was being bonded vibrated, so that the vibration was transmitted to the lead to which the wire had been bonded, resulting in a breaking of the wire. Where the lead holding surface 22a had a Rz of 10 μm while the second supporting surface zone 20b had a Rz of 1.5 μm, although the degree to which the vibration was transmitted between the leads 18 was decreased, the vibration of the lead 18 to which the wire had been bonded was not substantially inhibited. Where the lead holding surface 22a had a Rz of 30 μm while the second supporting surface zone 20b had a Rz of 1.5 μm, the vibration of the lead 18 to which the wire had been bonded was substantially inhibited, allowing the burnout rate of the wires to be significantly reduced.

As such, the inhibition or prevention of the lead vibration in the second bonding process is achieved (in other words, the ultrasonic energy is efficiently converted into bonding energy) by setting a ten-point surface roughness Rz of the lead holding surface 22a to be equal to or more than 10 μm, preferably equal to or more than 30 μm. However, the lead holding surface 22a preferably has a Rz of equal to or less than 50 μm. Where the lead holding surface 22a has a Rz of more than 50 μm, the increased irregularity of the lead holding surface 22a does not allow for a sufficient amount of surface area in contact with the leads 18. The value of Rz may vary depending on the number and/or widths of the leads 18. For example, where the number of the leads 18 is smaller, the same pressing force with which the lead holding member 22 is pressed against the heater plate 4 results in a larger pressing force per lead 18. Thus, the lead vibration in the second bonding process can be sufficiently inhibited or prevented with the lead holding surface 22a having a Rz of less than 30 μm.

In order to increase the heat transfer from the heater plate 4 to the lead frame 3, the second supporting surface zone 20b of the heater plate 4 has a roughness as lower as possible, preferably equal to or less than 1.5 μm in term of the ten-point surface roughness Rz. However, the second supporting surface zone 20b preferably has a Rz of equal to or more than 0.5 μm. Where the second supporting surface zone 20b has a Rz of less than 0.5 μm, the lead 18 may easily slip on the second supporting surface zone 20b in the second bonding process.

It is to be noted that the maximum static friction force between the lead holding member 22 and the leads 18 can be increased by increasing a pressing force with which the lead holding member 22 is pressed against the leads 18. However, the increased pressing force may cause a deflection and deformation of the lead holding member 22. This may result in an insufficient pressing of the leads 18 (i.e., some of the leads 18 may not be sufficiently pressed down). It is also to be noted that the rigidity of the lead holding member 22 can be increased by increasing the thickness of the lead holding member 22. However, in order to avoid the interference between the lead holding member 22 and the horn 8 which is extended above the member 22, the maximum thickness would generally be about 2-4 mm.

In the present embodiment, the ultrasonic bonding is performed by the ball bonding process using a capillary. In other words, in the embodiment, a bonding tool for applying ultrasonic energy for the bonding between the electrode 14a and the wire 11 and between the wire 11 and the lead 18, includes at least the head 6, the horn 8 and the capillary 10. Alternatively, a wedge bonding process using a wedge tool (not shown) may be utilized.

### Second Embodiment

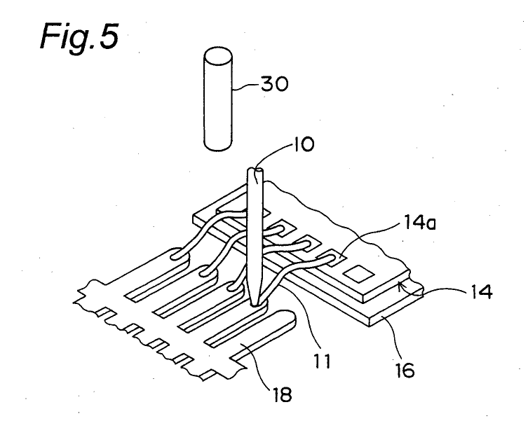

Referring now to FIG. 5, there is shown a second embodiment of the ultrasonic bonding device or wire bonding device of the present invention. The device includes an AE (acoustic emission) sensor 30. In the second bonding process with regard to each of the leads 18, the AE sensor 30 detects a vibration (resonance) of the other lead(s) to which the wire(s) have already been bonded, the vibration being caused by the transmission of the ultrasonic vibration in the lead 18 to which the wire is being bonded. The wire bonding device is designed to receive a signal, which indicates that an undesired vibration has occurred, from the AE sensor 30 when it detects the resonance of the leads 18 to which the wires 11 have already been bonded, so that the device stops the bonding operation.

In the embodiment, the generation of an undesired vibration can be readily detected to stop the bonding operation, thereby preventing a wire breaking.

### Third Embodiment

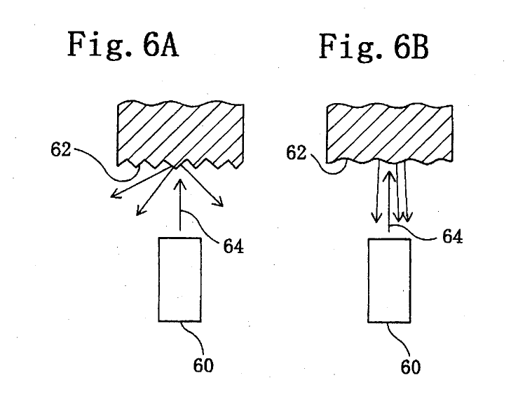

Referring now to FIGS. 6A and 6B, the ultrasonic bonding device of the third embodiment according to the present invention is similar to the device 2 shown in FIG. 1. The device of the embodiment further includes a detecting mechanism for determining a degree of abrasion on a surface to be treated, i.e., the holding surface 22a of the lead holding member 22 and/or the second supporting surface zone 20b of the heater plate 4. The detecting mechanism includes a laser sensor 60 having a light emitter (not shown) for emitting laser beam 64 in a direction generally perpendicular to the surface to be treated 62 and a light receiver (not shown). Where the surface to be treated 62 has a surface roughness within a predetermined range as shown in FIG. 6A, the laser beam 64 enters the surface to be treated 62 and light is diffused through the surface 62. As the surface to be treated 62 becomes smoother due to the abrasion as shown in FIG. 6B, the intensity of light received by the light receiver is increased. The ultrasonic bonding device receives a signal from the light receiver to determine the degree of abrasion. Where the surface to be treated 62 is abraded to some extent, the lead holding member 22 and/or heater plate 4 may be replaced with a new one or polished so that the holding surface 22a and/or supporting surface 20b has a surface roughness within the predetermined range.

According to the embodiment, by monitoring the degree to which the surface to be treated is abraded, a bonding failure can be inhibited, which might be caused due to the use of the surface to be treated, the roughness of which falls out of the predetermined range.

Instead of the laser sensor 60, a photoelectric sensor (not shown) having a light emitting diode as a light source of the light emitter may be used, so that the degree of abrasion of the surface to be treated can be determined based on a variation of the reflected light intensity.

According to the ultrasonic bonding apparatus and method, a thermal conduction from the heater plate to the lead frame is ensured and a wire breaking can be prevented by providing the lead holding member with an improved capacity of pressing the leads against the heater plate, resulting in an ultrasonic wire bonding with higher reliability.

1. An ultrasonic bonding apparatus comprising:
a heater plate on which a lead frame having a plurality of leads is positioned, wherein a semiconductor chip with a plurality of electrodes is mounted on the lead frame and the leads of the lead frame are supported on a supporting surface zone of the heater plate;
a holding member for pressing at least one of the leads of the lead frame against the supporting surface zone of the heater plate; and
a bonding tool for applying ultrasonic energy to a position where a wire is in contact with one of the electrodes of the semiconductor chip so that the wire is bonded to the electrode and for applying ultrasonic energy to a position where the wire is in contact with one of the leads so that the wire is bonded to the lead, wherein a holding surface of the holding member for contacting the at least one of the leads of the lead frame has a surface roughness higher than that of the supporting surface zone of the heater plate.

2. The ultrasonic bonding apparatus in accordance with claim 1, wherein the surface roughness of the holding surface of the holding member is a ten-point mean surface roughness Rz in the range of about 10-50 μm.

3. The ultrasonic bonding apparatus in accordance with claim 2, wherein the surface roughness of the supporting surface of the heater plate is a ten-point mean surface roughness Rz in the range of about 0.5-1.5 μm.

4. The ultrasonic bonding apparatus in accordance with claim 1, further comprising a detector for detecting vibration of a first lead when a wire is bonded to a second lead, the first and second leads being two of the leads of the lead frame, wherein
the first lead and the corresponding electrode of the semiconductor have been connected with each other via a wire, and
the bonding operation between the second lead and the wire is stopped when the detector detects an undesired vibration of the first lead.

5. The ultrasonic bonding apparatus in accordance with claim 1, further comprising a sensor for emitting light toward the holding surface of the holding member and/or the supporting surface of the heater plate to detect a reflected light intensity.

6. An ultrasonic bonding method comprising
positioning a lead frame having a plurality of leads in place on a heater plate, wherein a semiconductor chip with a plurality of electrodes is mounted on the lead frame and the leads of the lead frame are supported on a supporting surface zone of the heater plate;
pressing at least one of the leads of the lead frame against the supporting surface zone of the heater plate with a holding member;
applying ultrasonic energy to a position where a wire is in contact with one of the electrodes of the semiconductor chip and bonding the wire to the electrode; and
applying ultrasonic energy to a position where the wire is in contact with one of the leads so that the wire is bonded to the lead, wherein a holding surface of the holding member for contact with the at least one of the leads has a surface roughness higher than that of the supporting surface zone of the heater plate.
